(19) United States
(12) Patent Application Publication
(10) Pub. No.: US 2003/0078005 A1
(43) Pub. Date: Apr. 24, 2003

(54) Apparatus and methods for noise suppression in communications systems

(75) Inventor: Elyahu Recht, Kfar-Gibton (IL)

Correspondence Address: Ladas & Parry, 26 West 61st Street, New York, NY, 10023, US

(73) Assignee: AIRNET LTD.

(21) Appl. No.: 09/982,282

(22) Filed: Oct. 18, 2001

(51) Int. Cl. H04B 1/10

(52) U.S. Cl. 455/63; 455/41

(57) ABSTRACT

A communication circuit and method including communications circuitry having an input and an output and a noise suppressor. The noise suppressor includes an amorphous magnetic core and a bifilar winding around said amorphous magnetic core.

### FIELD OF THE INVENTION

The present invention relates to noise suppression circuitry and methods generally.

### BACKGROUND OF THE INVENTION

The following U.S. Patents are believed to represent the current state of the art: Nos. 6,241,920; 6,239,379; 6,183,657; 6,091,025; 6,089,917; 6,069,803; 6,014,071; 6,004,661; 6,002,593; 5,994,992; 5,990,417; 5,978,231; 5,977,853; 5,977,754; 5,966,064; 5,850,336; 5,841,335; 5,831,505; 5,825,272; 5,793,273; 5,635,890; 5,629,661; 5,619,174; 5,611,871; 5,581,224; 5,522,948; 5,506,559; 5,252,148; 5,242,760; 5,225,006; 5,192,375; 5,178,689; 5,067,991; 5,030,933; 5,019,190; 5,012,125; 4,985,088; 4,870,729; 4,859,256; 4,847,575; 4,741,484; 4,637,843; 4,472,693; 4,325,733.

### SUMMARY OF THE INVENTION

The present invention seeks to provide improved noise suppression circuitry and methods.

There is thus provided in accordance with a preferred embodiment of the present invention a communication circuit, which includes communications circuitry having an input, an output and a noise suppressor. The noise suppressor includes an amorphous magnetic core and a bifilar winding around said amorphous magnetic core.

There is also provided in accordance with another preferred embodiment of the present invention a communication noise suppressing method, which includes providing a communications circuitry having an input and an output, providing an amorphous magnetic core, winding a bifilar winding around said amorphous magnetic core and in series with at least one of said communications circuitry input and communications circuitry output and passing a communication signal from said input, through said bifilar winding and to said output for suppressing noise in said communication signal.

Further in accordance with a preferred embodiment of the present invention the amorphous magnetic core has a toroidal shape. Alternatively, the amorphous magnetic core has a closed E-shape.

There is also provided in accordance with a preferred embodiment of the present invention a noise suppressor assembly, which includes a multiplicity of noise suppressors. At least one of said multiplicity of noise suppressors includes an amorphous magnetic core and a bifilar winding wound around said amorphous magnetic core.

There is further provided in accordance with a preferred embodiment of the present invention a noise suppressing method, which includes providing a multiplicity of magnetic cores, at least one of said multiplicity of magnetic cores includes an amorphous magnetic core, winding a bifilar winding around each of said plurality of magnetic cores, connecting said bifilar windings in series and passing a signal through said bifilar windings for suppressing noise in said signal.

Further in accordance with a preferred embodiment of the present invention the multiplicity of noise suppressors includes at least first and second noise suppressors having cores containing different amorphous magnetic materials.

There is further provided in accordance with a preferred embodiment of the present invention a noise suppressor assembly, which includes at least one noise suppressor. The noise suppressor includes a core, including ferrite material and an amorphous magnetic material, and a bifilar winding wound around said core.

There is also provided in accordance with yet a further preferred embodiment of the present invention a noise suppressing method. The method includes providing at least one core including ferrite material and an amorphous magnetic material, winding a bifilar winding around said at least one core and passing a signal through said bifilar winding for suppressing noise in said signal.

Further in accordance with a preferred embodiment of the present invention the noise suppressor comprises a multiplicity of noise suppressors, which include at least first and second noise suppressors having cores containing different amorphous magnetic materials.

There is also provided in accordance with a further preferred embodiment of the present invention a wide band noise suppressor, which includes a core assembly comprising a multiplicity of amorphous magnetic cores and a bifilar winding wound around said core assembly.

There is further provided in accordance with another preferred embodiment of the present invention a wide band noise suppressing method. The method includes providing a core assembly comprising a multiplicity of amorphous magnetic cores, winding a bifilar winding wound around said core assembly and passing a signal through said bifilar winding for suppressing noise in said signal.

There is further provided in accordance with yet a further preferred embodiment of the present invention a wide band noise suppressor, which includes a core comprising a mixture of a plurality of different amorphous magnetic materials and a bifilar winding wound around said core.

There is also provided in accordance with a further preferred embodiment of the present invention a wide band noise suppressing method. The method includes providing a core comprising a mixture of a plurality of different amorphous magnetic materials, winding a bifilar winding wound around said core and passing a signal through said bifilar winding for suppressing noise in said signal.

Further in accordance with a preferred embodiment of the present invention the amorphous magnetic core has a toroidal shape. Alternatively, the amorphous magnetic core has a closed E-shape.

There is further provided in accordance with yet another preferred embodiment of the present invention a signal to interference enhancer. The enhancer includes at least one passive analog circuit, which operates to decrease radio frequency interference in a received signal and at least one active analog circuit, which operates to decrease radio frequency interference in said received signal. Typically, the passive analog circuit and the active analog circuit are arranged in series for providing radio frequency signal to interference enhancement to said received signal.

There is further provided in accordance with yet another preferred embodiment of the present invention a signal to interference enhancing method, which includes providing at least one passive analog circuit operative to decrease radio frequency interference in a received signal, providing at least one active analog circuit operative to decrease radio frequency interference in said received signal, arranging the passive analog circuit and the active analog circuit in series and passing a radio frequency signal through said passive analog circuit and said active analog circuit for enhancing said signal to interference therein.

Further in accordance with a preferred embodiment of the present invention the active analog circuit cancels common mode interference.

Still further in accordance with a preferred embodiment of the present invention the passive analog circuit reduces the amplitude of common mode interference.

Additionally in accordance with a preferred embodiment of the present invention the passive analog circuit operates in a frequency range which is at least partially non-overlapping with a frequency range of operation of said at least one active analog circuit.

Further in accordance with a preferred embodiment of the present invention the passive analog circuit is operative to reduce non-common mode interference due to imperfect balancing of first and second transmission lines by filtering the common mode interference.

Still further in accordance with a preferred embodiment of the present invention the passive analog circuit employs an EMI filter to attenuate interference at frequencies above a desired frequency pass band and employs a plurality of cascaded common mode chokes connected in series with said EMI filter to attenuate interference at frequencies within said desired frequency pass band.

Moreover in accordance with a preferred embodiment of the present invention the passive analog circuit includes a low-pass EMI filter operative to attenuate interference at frequencies above a desired frequency pass band and a plurality of cascaded common mode chokes connected in series with said EMI filter. Typically, the common mode chokes operate to attenuate interference at frequencies within said desired frequency pass band.

Additionally in accordance with a preferred embodiment of the present invention the signal to interference enhancing method also includes employing metallic barriers located at said filter and at said cascaded common mode chokes to reduce parasitic input to output interference coupling.

Preferably, the core comprises separate core elements made of said metal-based amorphous material and of said ferrite material.

Still further in accordance with a preferred embodiment of the present invention the signal to interference enhancer also includes metallic barriers located at said filter and at said cascaded common mode chokes in order to reduce parasitic input to output interference coupling.

Additionally in accordance with a preferred embodiment of the present invention the plurality of cascaded common mode chokes include at least one choke. The choke includes at least one core comprising a metal-based amorphous material and a ferrite material and at least one coil wound about said at least one core.

Moreover in accordance with a preferred embodiment of the present invention the amorphous material comprises at least one of cobalt and nickel.

Further in accordance with a preferred embodiment of the present invention the ferrite material comprises silicon steel permalloy.

Still further in accordance with a preferred embodiment of the present invention the amorphous material has magnetic permeability between 20,000-100,000 and has a saturation current of at least 5 Amperes.

Additionally in accordance with a preferred embodiment of the present invention the magnetic permeability varies with changes in temperature between −30° C. and 85° C. by less than 5%.

Further in accordance with a preferred embodiment of the present invention the core comprises separate core elements made of said metal-based amorphous material and of said ferrite material.

There is also provided in accordance with another preferred embodiment of the present invention a signal to interference enhancer, which includes a low-pass EMI filter operative to attenuate interference at frequencies above a desired frequency pass band and a plurality of cascaded common mode chokes connected in series with said EMI filter. Typically, the common mode chokes operate to attenuate interference at frequencies within said desired frequency pass band.

There is also provided in accordance with a preferred embodiment of the present invention a signal to interference enhancer embodied in a circuit package, which includes a low-pass EMI filter operative to attenuate interference at frequencies above a desired frequency pass band, a plurality of cascaded common mode chokes connected in series with said EMI filter. Typically, the common mode chokes operate to attenuate interference at frequencies within said desired frequency pass band. The metallic barriers located at said filter and at said cascaded common mode chokes reduce parasitic input to output interference coupling.

Additionally in accordance with a preferred embodiment of the present invention the plurality of cascaded common mode chokes include at least one choke. The choke includes at least one core comprising a metal-based amorphous material and a ferrite material and at least one coil wound about said at least one core.

Further in accordance with a preferred embodiment of the present invention the ferrite material comprises silicon steel permalloy.

Still further in accordance with a preferred embodiment of the present invention the amorphous material has magnetic permeability between 20,000-100,000 and has a saturation current of at least 5 Amperes.

Additionally in accordance with a preferred embodiment of the present invention the magnetic permeability varies with changes in temperature between −30° C. and 85° C. by less than 5%.

Further in accordance with a preferred embodiment of the present invention the core comprises separate core elements made of said metal-based amorphous material and of said ferrite material.

Still further in accordance with a preferred embodiment of the present invention the signal to interference enhancer also includes metallic barriers located at said filter and at said cascaded common mode chokes in order to reduce parasitic input to output interference coupling.

There is also provided in accordance with yet a further preferred embodiment of the present invention a signal to interference enhancing method, which includes employing a low-pass EMI filter to attenuate interference at frequencies above a desired frequency pass band, employing a plurality of cascaded common mode chokes connected in series with said EMI filter to attenuate interference at frequencies within said desired frequency pass band and employing metallic barriers located at said filter and at said cascaded common mode chokes to reduce parasitic input to output interference coupling.

There is further provided in accordance with yet another preferred embodiment of the present invention a signal to interference enhancing method, which includes employing a low-pass EMI filter to attenuate interference above a desired frequency pass band, employing a plurality of cascaded common mode chokes connected in series with said EMI filter to attenuate interference at frequencies within said desired frequency pass band and passing a signal through said low-pass EMI filter and said plurality of cascaded common mode chokes for suppressing noise in said signal.

Further in accordance with a preferred embodiment of the present invention the signal to interference enhancing method also includes metallic barriers located at said filter and at said cascaded common mode chokes in order to reduce parasitic input to output interference coupling.

Further in accordance with a preferred embodiment of the present invention the amorphous material comprises at least one of cobalt and nickel.

There is also provided in accordance with yet a further preferred embodiment of the present invention a noise suppressor, which includes an amorphous magnetic core, a bifilar winding wound around said amorphous magnetic core. Typically the amorphous magnetic core has a closed E-shape.

There is also provided in accordance with yet another preferred embodiment of the present invention a signal to interference enhancer, which includes at least one passive analog circuit operative to decrease radio frequency interference in a received signal and at least one active analog circuit operative to decrease radio frequency interference in said received signal. Typically, the passive analog circuit and the active analog circuit being arranged in series for providing radio frequency signal to interference enhancement to said received signal. Preferably, the active analog circuit operates to interface with a modem.

There is further provided in accordance with a preferred embodiment of the present invention a signal to interference enhancer, which includes at least one passive analog circuit operative to decrease radio frequency interference in a received signal and at least one active analog circuit operative to decrease radio frequency interference in said received signal. Typically, the passive analog circuit and the one active analog circuit being arranged in series for providing radio frequency signal to interference enhancement to said received signal. Preferably, the active analog circuit operates to interface with an A/D converter.

There is also provided in accordance with yet another preferred embodiment of the present invention a signal to interference enhancing repeater. The repeater includes a first passive analog circuit operative to decrease radio frequency interference in a received signal, at least one active analog circuit operative to decrease radio frequency interference in said received signal and a second passive analog circuit operative to decrease radio frequency interference in a received signal. Typically, the first passive analog circuit, the active analog circuit and said second passive analog circuit are arranged in series for providing radio frequency signal to interference enhancement to said received signal. Preferably, the one active analog circuit operates as an analog repeater.

There is further provided in accordance with yet another preferred embodiment of the present invention a signal to interference enhancer, which includes at least one passive analog circuit comprising a differential input and operative to decrease radio frequency interference in a received signal and at least one active analog circuit comprising a single-ended output and operative to decrease radio frequency interference in said received signal. Typically, the passive analog circuit and the active analog circuit being arranged in series for providing radio frequency signal to interference enhancement to said received signal. Preferably, the differential input serves as the input of the cascaded circuit and said single-ended output serves as the output of the cascaded circuits.

There is also provided in accordance with yet a firer preferred embodiment of the present invention a signal to interference enhancer, which includes at least one passive analog circuit operative to decrease radio frequency interference in a received signal and at least one active analog circuit operative to decrease radio frequency interference in said received signal. Typically, the passive analog circuit and the one active analog circuit being arranged in series for providing radio frequency signal to interference enhancement to said received signal. Preferably, the first said of at least one passive analog circuit includes a differential input and the last of said at least one active analog circuit includes a single-ended output.

There is also provided in accordance with yet a preferred embodiment of the present invention a signal to interference enhancer, which includes at least one passive analog circuit operative to decrease radio frequency interference in a received signal and at least one active analog circuit operative to decrease radio frequency interference in said received signal. Typically, the passive analog circuit and the active analog circuit being arranged in series for providing radio frequency signal to interference enhancement to said received signal. Typically, the first of said at least one passive analog circuit includes a single-ended input and the last of said at least one active analog circuit includes a single-ended output.

There is further provided in accordance with yet another preferred embodiment of the present invention a signal to interference enhancer, which includes at least one passive analog circuit operative to decrease radio frequency interference in a received signal and at least one active analog circuit operative to decrease radio frequency interference in said received signal. Typically, the passive analog circuit and the active analog circuit being arranged in series for providing radio frequency signal to interference enhancement to said received signal. Preferably, the first of said at least one passive analog circuit includes a single-ended input and the last of said at least one active analog circuit includes a differential output.

There is also provided in accordance with yet a further preferred embodiment of the present invention a signal to interference enhancer, which includes at least one passive analog circuit operative to decrease radio frequency interference in a received signal and at least one active analog circuit operative to decrease radio frequency interference in said received signal. Typically, the passive analog circuit and the active analog circuit being arranged in series for providing radio frequency signal to interference enhancement to said received signal. Preferably, the active analog circuit operates to interface with an XDSL modem.

There is further provided in accordance with yet another preferred embodiment of the present invention a noise suppressing transformer assembly, which includes at least one noise suppressor. The noise suppressor, which includes an amorphous magnetic core and a bifilar winding wound around said amorphous magnetic core, and a transformer. The transformer includes at least one core comprising at least a ferrite material and at least one coil wound about said at least one core. Typically, the noise suppressor and said transformer are arranged in series.

There is provided in accordance with yet a further preferred embodiment of the present invention a signal to interference enhancer embodied in a circuit package. The enhancer includes a low-pass EMI filter operative to attenuate interference at frequencies above a desired frequency pass band and a plurality of cascaded common mode chokes connected in series with said EMI filter, said common mode chokes being operative to attenuate interference at frequencies within said desired frequency pass band. Typically, each of said low-pass EMI filter and said plurality of cascaded common mode being contained in a separate metallic enclosure.

There is further provided in accordance with yet a further preferred embodiment of the present invention a signal to interference enhancer embodied in a circuit package, which includes a low-pass EMI filter operative to attenuate interference at frequencies above a desired frequency pass band and a plurality of cascaded common mode chokes connected in series with said EMI filter, said common mode chokes being operative to attenuate interference at frequencies within said desired frequency pass band. Typically, the plurality of cascaded common mode chokes being contained in a metal enclosure and said EMI filter being embodied in a feed-through device inserted in a wall of said enclosure.

There is also provided in accordance with yet another preferred embodiment of the present invention a transformer, which includes at least one core comprising at least one of metal-based amorphous material and a ferrite material, at least one coil wound about said at least one core and at least one aluminum foil shield wound around at said least one coil.

There is further provided in accordance with a preferred embodiment of the present invention a noise suppressor embodied in a circuit package, which includes an amorphous magnetic core, a bifilar winding wound around said amorphous magnetic core, said bifilar winding comprising an input portion and an output portion and a metallic barrier located across said amorphous magnetic core and between said input portion and said output portion in order to reduce parasitic input to output interference coupling.

### BRIEF DESCRIPTION OF THE DRAWINGS

The present invention will be understood and appreciated more fully from the following detailed description, taken in conjunction with the drawings in which:

FIGS. 1A and 1B are each a simplified illustration of a noise suppressor constructed and operative in accordance with a preferred embodiment of the present invention;

FIG. 2 is a simplified illustration of a plurality of noise suppressors of the type shown in FIG. 1A, connected in series;

FIG. 3 is a simplified illustration of a noise suppressor of the general type shown in FIG. 1A, having a multilayer core;

FIG. 4 is a simplified circuit diagram of a passive magnetic circuit for enhancing signals relative to interference in accordance with a preferred embodiment of the present invention;

FIG. 5 is a simplified circuit diagram of a passive/active circuit for enhancing signals relative to interference in accordance with a preferred embodiment of the present invention, which is particularly suitable for incorporation into a hybrid circuit;

FIG. 6 is a simplified circuit diagram illustrating incorporation of multiple passive magnetic circuits of the type shown in FIG. 4 in an analog repeater;

FIG. 7 is a simplified circuit diagram illustrating incorporation of a passive magnetic circuit of the type shown in FIG. 4 in an active differential input to single-ended output circuit;

FIG. 8 is a simplified circuit diagram illustrating incorporation of a passive magnetic circuit of the type shown in FIG. 4 in an active single-ended input to single-ended output circuit;

FIG. 9 is a simplified circuit diagram illustrating incorporation of a passive magnetic circuit of the type shown in FIG. 4 in an active single-ended input to differential output circuit;

FIG. 10 is a simplified circuit diagram of a circuit for enhancing signals relative to interference in accordance with a preferred embodiment of the present invention, incorporated into an XDSL modem;

FIG. 11 is a simplified illustration of a noise suppressing transformer assembly constructed and operative in accordance with a preferred embodiment of the present invention;

FIG. 12 is a simplified illustration of a packaged circuit of the type shown in FIG. 4, including metallic enclosures and barriers;

FIG. 13 is a simplified illustration of a packaged circuit incorporating a noise suppressor of the type shown in FIG. 1;

FIG. 14 is a simplified illustration of an insulating transformer that forms a part of the noise suppressing transformer of FIG. 11; and

FIG. 15 is a simplified illustration of a packaged circuit incorporating a noise suppressor of the type shown in FIG. 1 and having a metallic enclosure and barrier.

### DETAILED DESCRIPTION OF PREFERRED EMBODIMENTS

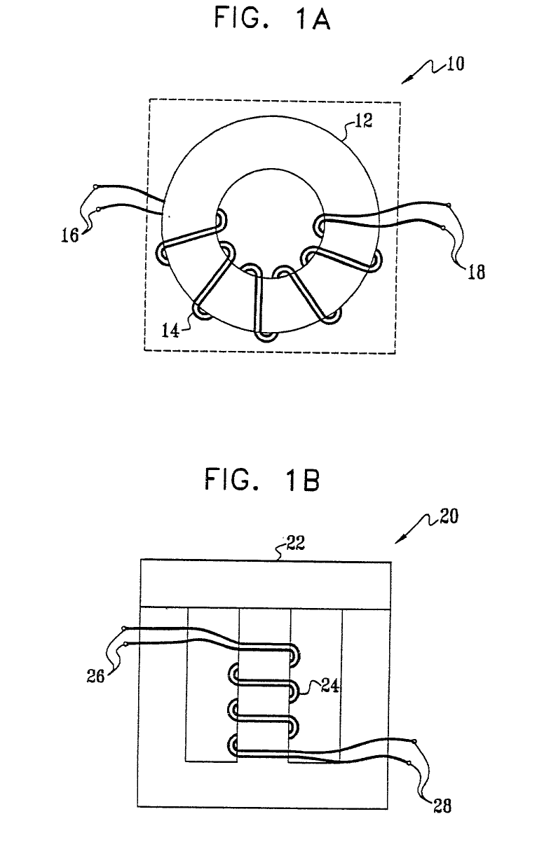

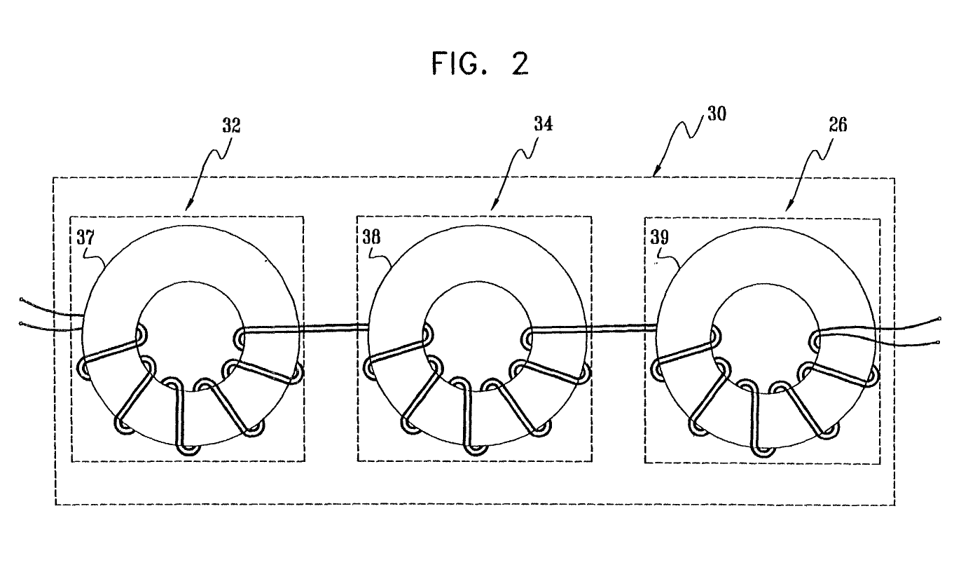

Reference is now made to FIGS. 1A and 1B, which are simplified pictorial illustrations of two types of noise suppressors, also known as common mode chokes, constructed and operative in accordance with a preferred embodiment of the present invention. The noise suppressers are preferably used to suppress incoming line noise, such as longitudinal interference, The noise suppressor of FIG. 1A is designated by reference numeral 10 and comprises an amorphous magnetic core 12 and a bifilar winding 14 wound around the amorphous magnetic core 12. The bifilar winding 14 preferably has a pair of input terminals 16 and a pair of output terminals 18. Preferably the core 12 has a closed shape such as a toroidal shape and the bifilar winding 14 is wound around the core 12 so that the input terminals 16 and the output terminals 18 are arranged to be located on respective opposite sides of the core 12 in order to minimize electrical interference between the input and the output.

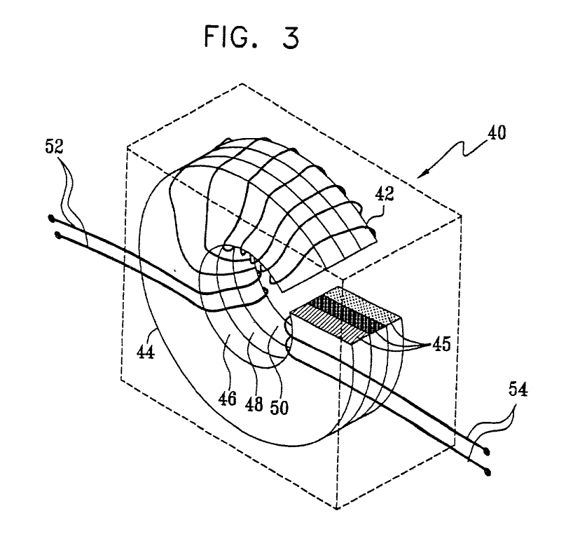

Core 12 preferably comprises a metal-based amorphous material and a ferrite material. Preferably, the ferrite material comprises silicon steel permalloy. In accordance with a preferred embodiment of the present invention, the amorphous material has a relatively high magnetic permeability, which most preferably is above 20,000. Preferably, the magnetic permeability varies with changes in temperature between −30° C. and 85° C. by less than 5%. In accordance with a preferred embodiment of the present invention, the amorphous material has a saturation current of at least 5 Amperes. The core 12 may include separate core elements made of metal-based amorphous material and of ferrite material, as in the embodiment of FIG. 3. Alternatively, the amorphous material and the ferrite material may be mixed together. As a further alternative, the core need not include ferrite material. The amorphous magnetic material may be, for example, a composite material comprising cobalt or nickel.

Reference is now made to FIG. 1B, which illustrates another embodiment of a noise suppressor, here designated by reference numeral 20, which similarly comprises an amorphous magnetic core 22 and a bifilar winding 24 wound around the amorphous magnetic core 22. The bifilar winding 24 preferably has a pair of input terminals 26 and a pair of output terminals 28. As distinct from the embodiment of FIG. 1A, the core 22 has an E-shape. The composition of the core of FIG. 1B may be identical to that of FIG. 1A.

Reference is now made to FIG. 2, which is a simplified pictorial illustration of a passive magnetic assembly 30 comprising three different noise suppressors which are typically of the type designated by reference numeral 10 in FIG. 1A, connected in series. Alternatively, the noise suppressors may be of the type designated by reference numeral 20 in FIG. 1B.

The noise suppressors of FIG. 2 are specifically designated by numerals 32, 34, and 36. Each of the noise suppressors 32, 34 and 36 has a different type of core, here specifically designated respectively by numerals 37, 38 and 39. Preferably each of the cores 37, 38 and 39 provides noise suppression characteristics that are optimal for a different set of requirements. Such requirements may be frequency range characteristics, saturation current characteristics and temperature range characteristics. For example, the noise suppressors 32, 34, and 36 may each be optimal for a different and adjacent frequency band so that the noise suppressor assembly 30 has combined wide band noise suppression characteristics. Alternatively or additionally, the noise suppressors 32, 34, and 36 may have different saturation currents so that the performance of the passive magnetic assembly 30 at different DC currents is better than the performance of each of the noise suppressors 32, 34 and 36 when operating independently. It is appreciated that any number of noise suppressors can be assembled to form the passive magnetic assembly 30 in order to achieve desired noise suppression characteristics.

It is appreciated that placing noise suppressors 32, 34 and 36 in various different orders in the passive magnetic assembly 30 may result in different overall noise suppression characteristics.

Preferably at least one of the noise suppressors 32, 34 and 36 comprises a core 12 made of amorphous magnetic material such as composite materials comprising cobalt or nickel.

Reference is now made to FIG. 3, which is a simplified pictorial illustration of a noise suppressor 40, which comprises a bifilar winding 42 wound around a core assembly 44 that comprises a plurality of core elements 45. Core elements 45 are each typically similar to core 12 of FIG. 1A but may be thinner.

According to a preferred embodiment of the present invention, core assembly 44 comprises three core elements 45, here specifically designated by numerals 46, 48 and 50, which are of the same shape, such as a toroidal shape, and are made of different materials. The bifilar winding 42 provides a pair of input terminals 52 and a pair of output terminals 54, preferably arranged on opposite sides of the core assembly 44 in order to minimize electrical interference between the input and the output.

Preferably each of the core elements 46, 48 and 50 provides noise suppression characteristics that are optimal for a different set of requirements. Such requirements may be frequency range characteristics, saturation current characteristics and temperature range characteristics. For example, the core elements 46, 48 and 50 may each be optimal for a different and adjacent frequency band so that the noise suppressor 40 has combined wide band noise suppression characteristics.

Alternatively or additionally, the core elements 46, 48 and 50 may have different saturation currents so that the performance of the noise suppressor 40 at different DC currents is better than the performance of each of the cores 46, 48 and 50 when operating independently. It is appreciated that any suitable number of core elements 45 can be assembled to form the noise suppressor 40 to achieve desired noise suppression characteristics. Preferably at least one of the core elements 45 is made of an amorphous magnetic material such as composite materials comprising cobalt or nickel.

Two or more noise suppressors 40 can be connected in series in order to achieve overall noise suppression characteristics that can not be achieved with a single noise suppressor 40. Preferably the two or more noise suppressors 40 employ different combinations of core elements 45.

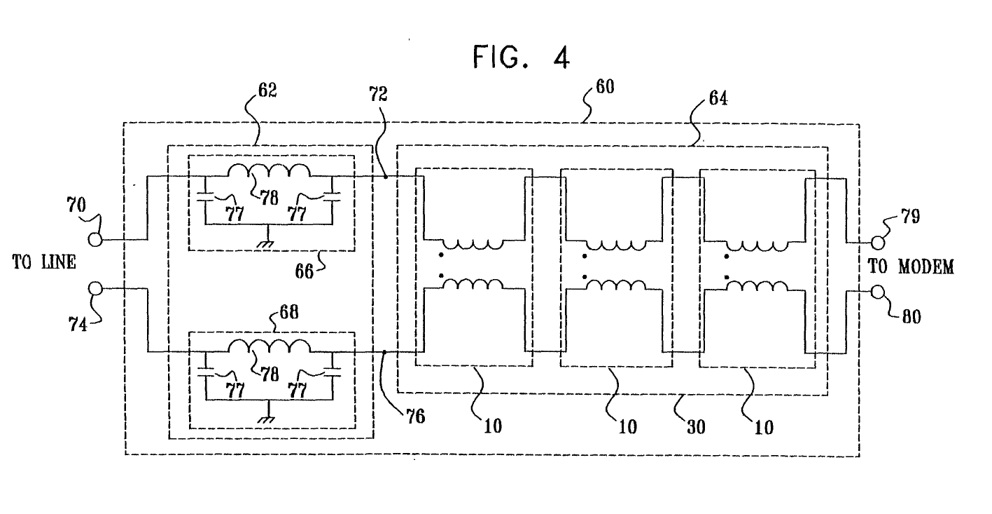

Reference is now made to FIG. 4, which is a simplified circuit diagram of a passive magnetic circuit 60 for enhancing signals relative to interference in accordance with a preferred embodiment of the present invention, The passive magnetic circuit 60 of FIG. 4 includes an input circuit 62 and a passive magnetic portion 64.

The input circuit 62 comprises a pair of low pass EMI filter assemblies 66 and 68, which are preferably identical. Low pass EMI filter assembly 66 connects between a terminal 70 and a first input terminal 72 of the passive magnetic portion 64. Low pass EMI filter assembly 68 connects between a terminal 74 and a second input terminal 76 of the passive magnetic portion 64. Each of low pass EMI filter assemblies 66 and 68 typically comprises a pair of capacitors 77 arranged on either side of an inductor 78 and is operative to attenuate interference at frequencies above a desired frequency pass band and.

In accordance with a preferred embodiment of the present invention, the passive magnetic portion 64 is preferably identical to the passive magnetic assembly 30 of FIG. 2. Alternatively, the passive magnetic portion 64 may comprise a single noise suppressor, such as noise suppressor 10 shown in FIG. 1A. As a further alternative, the passive magnetic portion 64 may comprise a noise suppressor such as noise suppressor 40 shown in FIG. 3. As yet another alternative, the passive magnetic portion 64 may comprise a plurality of noise suppressors, such as noise suppressors 40. Irrespective of its specific configuration, the passive magnetic portion 64 defines a pair of terminals 79 and 80.

Typically, terminals 70 and 74 are connected to a communication line and terminals 79 and 80 are connected to a modem. Alternatively, terminals 70 and 74 may be connected to a modem and terminals 79 and 80 are connected to a communication line.

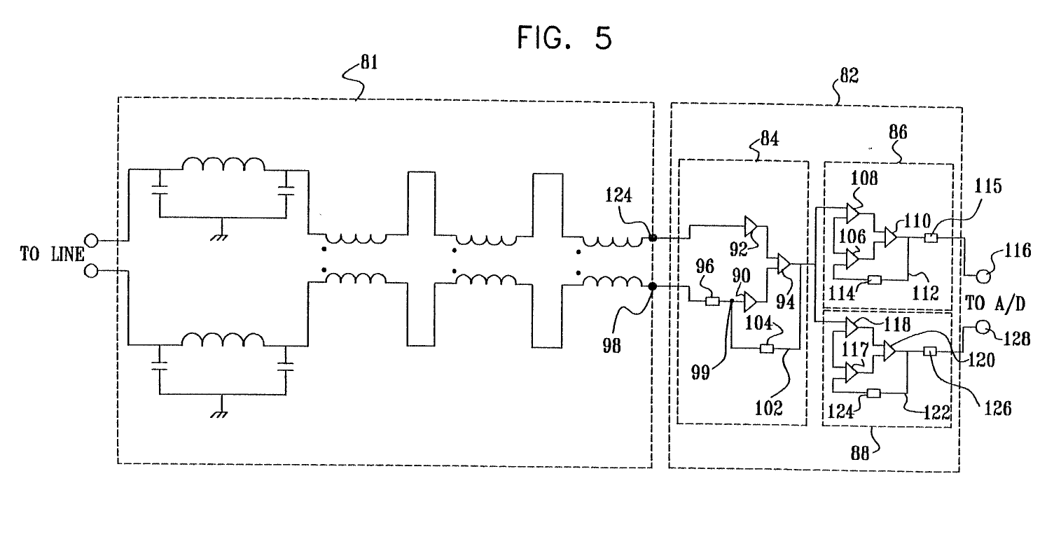

Reference is now made to FIG. 5, which is a simplified circuit diagram of a combined passive and active circuitry for enhancing signals relative to interference in accordance with a preferred embodiment of the present invention. The circuit of FIG. 5, which is particularly suitable for incorporating into a hybrid circuit, includes a passive portion 81, which is preferably identical to the circuitry of FIG. 4, and an active portion 82 preferably comprising three operational amplifier assemblies 84, 86 and 88.

Operational amplifier assembly 84 typically comprises three amplifiers 90, 92 and 94, connected as shown in a feedback arrangement, wherein a resistor 96 is connected in series between an output terminal 98 of the passive portion 81 and a junction 99 of an input to amplifier 90. A feedback connection 102 from an output of amplifier 94 to the input of amplifier 90 is provided and includes a feedback resistor 104 connected between the output of amplifier 94 and the input to amplifier 90.

Operational amplifier assembly 86 typically comprises three amplifiers 106, 108 and 110 connected as shown in a feedback arrangement, wherein a feedback connection 112 is provided from an output of amplifier 110 to the input of amplifier 106. A feedback resistor 114 is connected in the feedback connection 112 between the output of the amplifier 110 and the input of amplifier 106.

Operational amplifier assembly 88 typically comprises three amplifiers 116, 118 and 120 connected as shown in a feedback arrangement, wherein a feedback connection 122 is provided from an output of amplifier 120 to the input of amplifier 116. A feedback resistor 124 is connected between the output of amplifier 120 and the input of amplifier 116.

It is noted that operational amplifier assemblies 86 and 88 may be identical in structure but may have different electrical connections. For example, an output from operational amplifier assembly 84, may be supplied to a non-inverting input of amplifier 108 of assembly 86, while an output from operational amplifier 84 may be supplied to an inverting input of amplifier 118 of assembly 88.

It is appreciated that although the use of operational amplifier assemblies is preferred, other suitable types of differential amplifier assemblies may be employed.

It is further appreciated that the gain of operational amplifier assembly 84 is governed by the ratio of the resistance of resistors 104 and 96.

The active portion 82 of the circuit of FIG. 5 is preferably characterized by stable gain and by a high common mode rejection ratio over a wide frequency range.

The functionality of active portion 82 may be summarized as follows:

1. Provision of impedance matching between the balanced connection 98 and 124 at the output of the passive portion 81 and a balanced connection 126 and 128 at the input to an A/D converter (not shown) or a modem chip-set (not shown).

2. Provision of gain at least partially sufficient to compensate for signal attenuation in the passive portion 80 and the line leading thereto.

Operational amplifier assembly 86 typically comprises three amplifiers 106, 108 and 110 connected as shown in a feedback arrangement, wherein a feedback connection 112 is provided from an output of amplifier 110 to the input of amplifier 106. A feedback resistor 14 is connected in the feedback connection 112 between the output of the amplifier 1 10 and the input of amplifier 106. The output of amplifier 110 is also connected via an impedance matching resistor 115 to terminal 116 of the active portion 82.

Operational amplifier assembly 88 typically comprises three amplifiers 117, 118 and 120 connected as shown in a feedback arrangement, wherein a feedback connection 122 is provided from an output of amplifier 120 to the input of amplifier 117. A feedback resistor 124 is connected between the output of amplifier 120 and the input of amplifier 117. The output of amplifier 120 is also connected via an impedance matching resistor 126 to terminal 128 of the active portion 82.

It is appreciated that although the use of operational amplifier assemblies is preferred, other suitable types of differential amplifier assemblies may be employed.

It is further appreciated that the gain of operational amplifier assembly 84 is governed by the ratio of the resistance of resistors 104 and 96.

The active portion 82 of the circuit of FIG. 5 is preferably characterized by stable gain and by a high common mode rejection ratio over a wide frequency range.

The functionality of active portion 82 may be summarized as follows:

1. Provision of impedance matching between the balanced connection 98 and 124 at the output of the passive portion 81 and a balanced connection 116 and 128 at the input to an A/D converter (not shown) or a modem chip-set (not shown).

2. Provision of gain at least partially sufficient to compensate for signal attenuation in the passive portion 80 and the line leading thereto.

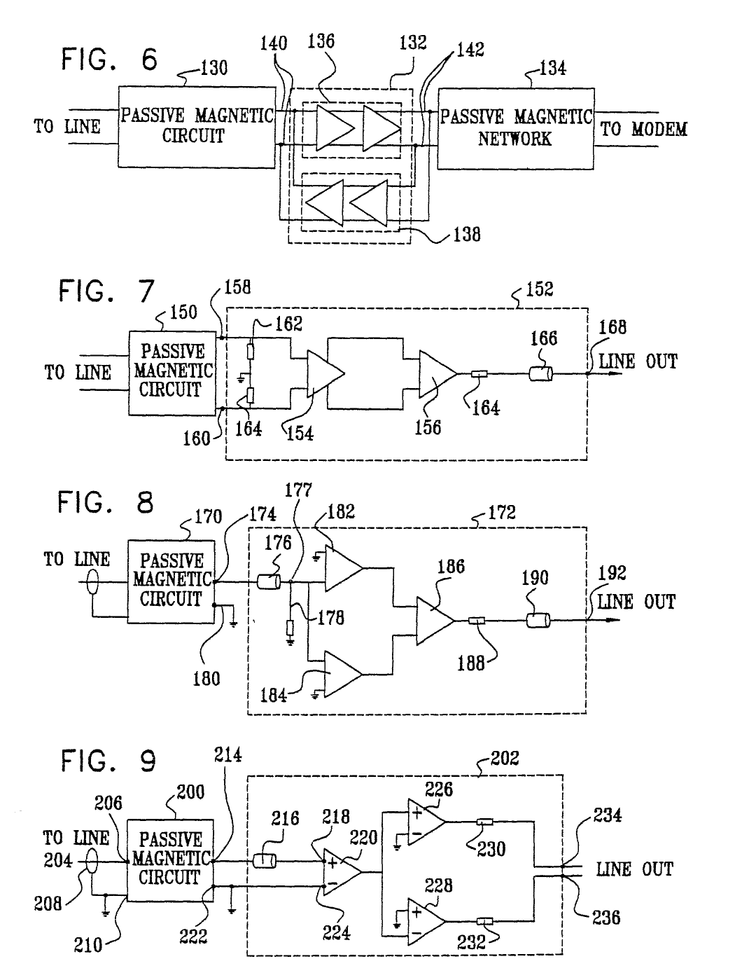

Reference is now made to FIG. 6, which is a simplified circuit diagram illustrating an analog repeater for enhancing signals relative to interference, constructed and operative in accordance with a preferred embodiment of the present invention. The circuit of FIG. 6 includes a first passive magnetic circuit portion 130, an active circuit portion 132 and a second passive magnetic network circuit portion 134. The active circuit 132 is connected between the passive magnetic portions 132 and 134. Each of the two passive portions 130 and 134 is preferably identical to the passive magnetic circuit 60 of FIG. 4.

The active portion 132 preferably comprises two operational amplifier assemblies 136 and 138. Inputs of operational amplifier assembly 136 are connected to terminals 140 of the first passive magnetic portion 132 and outputs of operational amplifier assembly 136 are connected to the terminals 142 of the second passive magnetic portion 136. Inputs of the operational amplifier assembly 138 are connected to terminals 142 of the second passive magnetic portion 136 and outputs of operational amplifier assembly 136 are connected to terminals 140 of the first passive portion 130.

Reference is now made to FIG. 7, which is a simplified circuit diagram illustrating incorporation of a passive magnetic circuit of the type shown in FIG. 4 into an active differential input to single-ended output circuit for enhancing signals relative to interference, constructed and operative in accordance with a preferred embodiment of the present invention. The circuit of FIG. 7 includes a passive portion 150 that is preferably identical to the circuitry of FIG. 4, and an active portion 152, preferably comprising an operational amplifier assembly.

In a preferred embodiment of the present invention described in FIG. 7, an operational amplifier assembly of the active portion 152 comprises two operational amplifiers 154 and 156. Inputs of the operational amplifier 154 are connected to output terminals 158 and 160 of the passive portion 150. The output terminals 158 and 160 of the passive portion 150 are also connected via termination resistors 162 and 164 to a common ground. In a preferred implementation of the present invention the termination resistors 162 and 164 have the same resistance.

Outputs of the operational amplifier 154 are connected to two corresponding inputs of the operational amplifier 156. An output of the operational amplifier 156 is connected to output 168 of the circuit of FIG. 7 via a resistor 164 and a ferrite element 166.

Reference is now made to FIG. 8, which is a simplified circuit diagram illustrating incorporating a passive magnetic circuit of the type shown in FIG. 4 into an active single-ended input to single-ended output circuit for enhancing signals relative to interference, constructed and operative in accordance with a preferred embodiment of the present invention. The circuit of FIG. 8 includes a passive circuit portion 170 that is preferably identical to the circuitry 60 of FIG. 4, and an active circuit portion 172, preferably comprising an operational amplifier assembly.

In a preferred implementation of the current invention, a first output 174 of the passive portion 170 is connected via a ferrite element 176 to a junction 177. The junction 177 is connected via a termination resistor 178 to a common ground. A second output 180 of the passive portion 170 is connected directly to common ground. Junction 177 is also connected to a non-inverting input of an operational amplifier 182 and to an inverting input of an operational amplifier 184. The other inputs of the operational amplifiers 182 and 184 are connected to common ground. The outputs of operational amplifiers 182 and 184 are each connected to an input of an operational amplifier 186. The output of operational amplifier 186 is connected via an impedance matching resistor 188 and a ferrite element 190 to an output 192 of the circuit of FIG. 8.

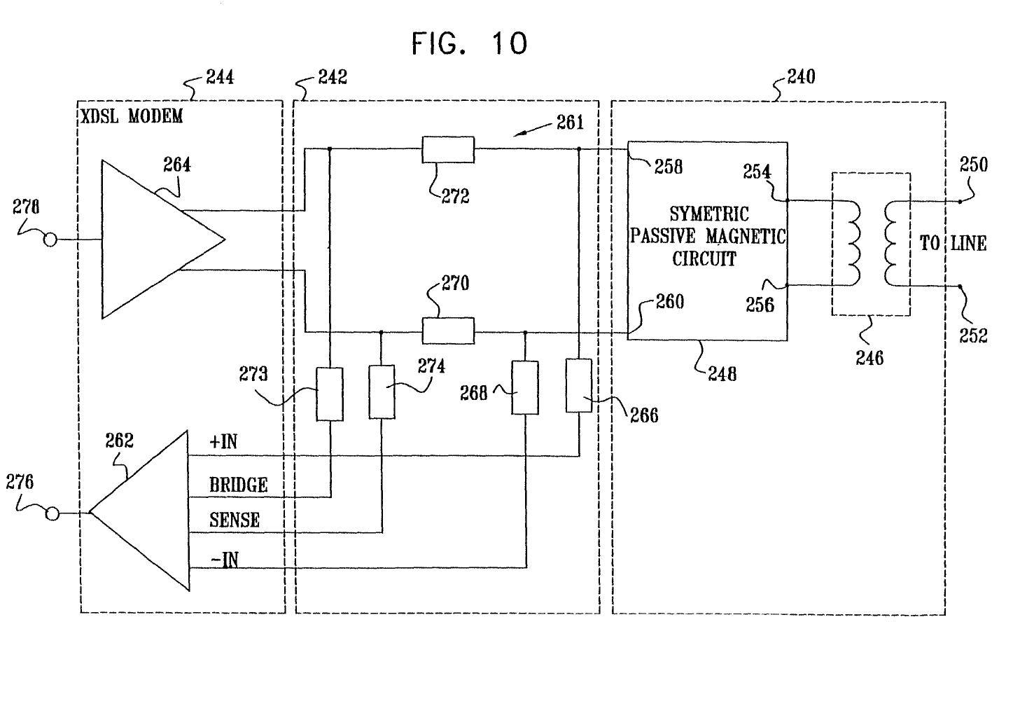

Reference is now made to FIG. 9, which is a simplified circuit diagram illustrating incorporation of a passive magnetic circuit of the type shown in FIG. 4 in an active single-ended input to differential output circuit for enhancing signals relative to interference, constructed and operative in accordance with a preferred embodiment of the present invention. The circuit of FIG. 9 includes a passive portion 200 that is preferably identical to the circuit 60 of FIG. 4, and an active portion 202, preferably comprising an operational amplifier assembly. A single-ended input 204 of the circuit of FIG. 9 is connected to a first input 206 of the passive portion 200 and a shield 208 of the single ended input is connected to a second input 210 of the passive portion 200 and to a common ground. A first output 214 of the passive portion 200 is connected via a ferrite element 216 to a first input 218 of an operational amplifier 220, preferably the non-inverting input, and a second output 222 of the passive portion 200 is connected to a second inverting input 224 of the operational amplifier 220 and to the common ground. An output of operational amplifier 220 is connected to a non-inverting input of an operational amplifier 226 and to an inverting input of an operational amplifier 228. An inverting input of operational amplifier 226 and a non-inverting input of operational amplifier 228 are grounded. The outputs of the operational amplifiers 226 and 228 are connected via impedance matching resistors 230 and 232 to respective outputs 234 and 236 of the circuit of FIG. 9.

Reference is now made to FIG. 10, which is a simplified circuit diagram of a circuit for enhancing signals relative to interference incorporated into an XDSL modem, in accordance with a preferred embodiment of the present invention. The circuit of FIG. 10 includes a line matching portion 240, an interconnecting portion 242 and an active portion 244 all connected in series.

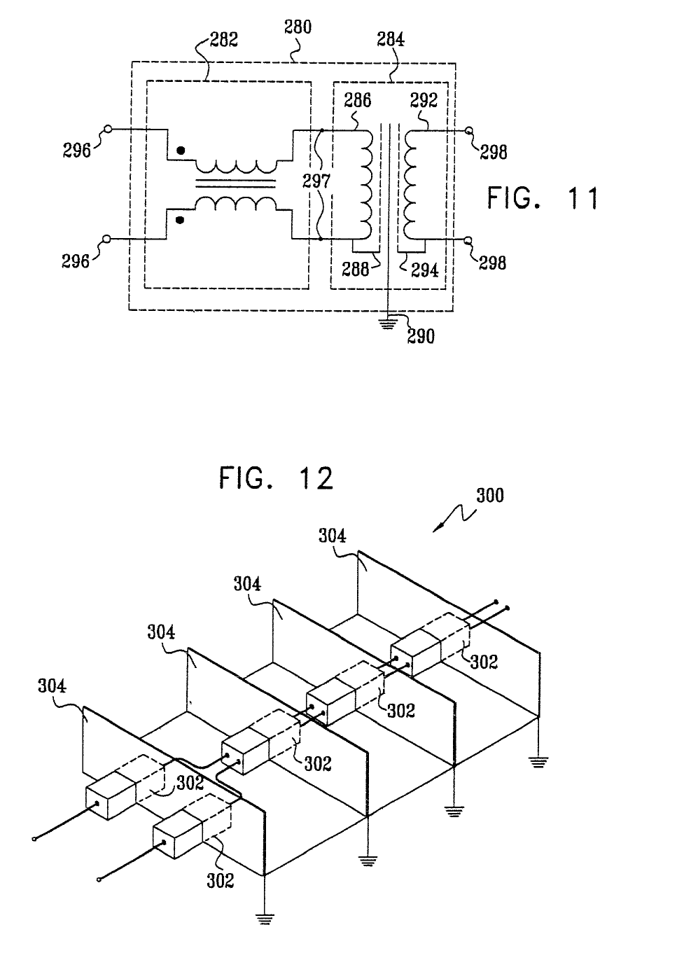

Typically, the line matching portion 240 comprises an insulating transformer 246 connected to a passive magnetic circuit 248. In a preferred embodiment of the present invention, the insulating transformer 246 is typically similar to an insulating transformer described hereinbelow in accordance with FIG. 14 or is identical to a noise suppressing transformer assembly described hereinbelow in accordance with FIG. 11. Passive magnetic circuit 248 is preferably identical to the circuitry of FIG. 4. Line terminals 250 and 252 of the circuit of FIG. 10 are connected via the insulating transformer 246 to terminals 254 and 256 of the passive magnetic circuit 248 and to terminals 258 and 260 of the passive magnetic circuit 248 are connected to the interconnecting portion 242.

In a preferred implementation of the present invention, the interconnecting portion 242 comprises a resistor network 261 and the active portion 244 comprises a receiver amplifier 262 and a transmitter amplifier 264. The terminals 258 and 260 of the passive magnetic circuit 248 are connected via resistors 266 and 268 to a non-inverting input and to an inverting input of the receiver amplifier 262, respectively. Terminals 258 and 260 of the passive magnetic circuit 248 are also connected via resistors 270 and 272 to an inverting output and a non-inverting output of the transmitter amplifier 264, respectively.

One output of the transmitter amplifier 264 is also connected, via a resistor 273, to a “BRIDGE” input of the receiver amplifier 262 and the other output of the transmitter amplifier 264 is also connected, via a resistor 274 to a “SENSE” input of the receiver amplifier 262. The output of receiver amplifier 262 is connected via a terminal 276 to the input of a digital portion (not shown) of the XDSL modem and the output of the digital portion of the XDSL modem is connected via a terminal 278 to an input of transmitter amplifier 264.

Reference is now made to FIG. 11, which is a simplified illustration of a noise suppressing transformer assembly constructed and operative in accordance with a preferred embodiment of the present invention. Noise suppressing transformer assembly 280 includes a noise suppressor portion 282 and an insulating transformer portion 284. In a preferred embodiment of the present invention, shown in FIG. 11, the noise suppressor portion 282 comprises the noise suppressor 10 of FIG. 1A, the noise suppressor 20 of FIG. 1B, the passive magnetic assembly 30 of FIG. 2, the noise suppressor 40 of FIG. 3, or the passive magnetic circuit 60 of FIG. 4.

The insulating transformer portion 284 typically comprises a primary coil 286, a first shielding aluminum foil 288 wrapped around primary coil 286, a ferrite core 290, a secondary coil 292 and a secondary shielding aluminum foil 294 wrapped around the secondary coil 292.

In a preferred embodiment of the present invention, shown in FIG. 11, the noise suppressor portion 282 is connected between terminals 296 of the noise suppression transformer assembly 280 and terminals 297 of the primary coil 286 of the insulating transformer portion 284. Terminals 298 of the secondary coil 292 of the insulating transformer portion 284 constitute another pair of terminals of the noise suppressing transformer assembly 280. Either terminals 296 or terminals 298 may be used as input terminals, while the other pair of terminals serves as output terminals. Foil 288 is preferably connected to the terminal 297, while foil 294 is preferably connected to the terminal 298.

In an alternative embodiment of the present invention, the noise suppressing transformer assembly 280 includes first noise suppressor portion 282 connected between the terminals 296 of the noise suppressing transformer assembly 280 and the primary coil 286 of the insulating transformer portion 284. Assembly 280 also includes insulating transformer portion 284 as well as a second noise suppressor portion (not shown), connected between the secondary coil 292 of the insulating transformer 284 and the output terminals 298 of the noise suppressing transformer assembly 280.

Reference is now made to FIG. 12, which is a simplified illustration of a packaged circuit 300 including metallic enclosures 302. In a preferred implementation of the present invention, the packaged circuit 300 embodies the circuit 60 of FIG. 4. In this preferred implementation, each of the low pass EMI filter assemblies 66 and 68 and the noise suppressors 10 shown in FIG. 4 is enclosed in a metallic enclosure 302. Optionally, metallic barriers 304 may be provided in electrically conductive engagement with enclosures 302 to isolate inputs of circuitry enclosed therein from outputs thereof. It is appreciated that this structure decreases the parasite capacitance between the inputs and the outputs of the circuitry enclosed in each enclosure 302, thus decreasing the crossover interference therebetween. Preferably enclosures 302 and barriers 304 are connected to a common ground. It is appreciated that any of the circuits described above in FIGS. 4 to 11 and the noise suppressors described above in FIGS. 1A 1B, 2 and 3 may be packaged in the manner illustrated generally in FIG. 12 and described hereinabove.

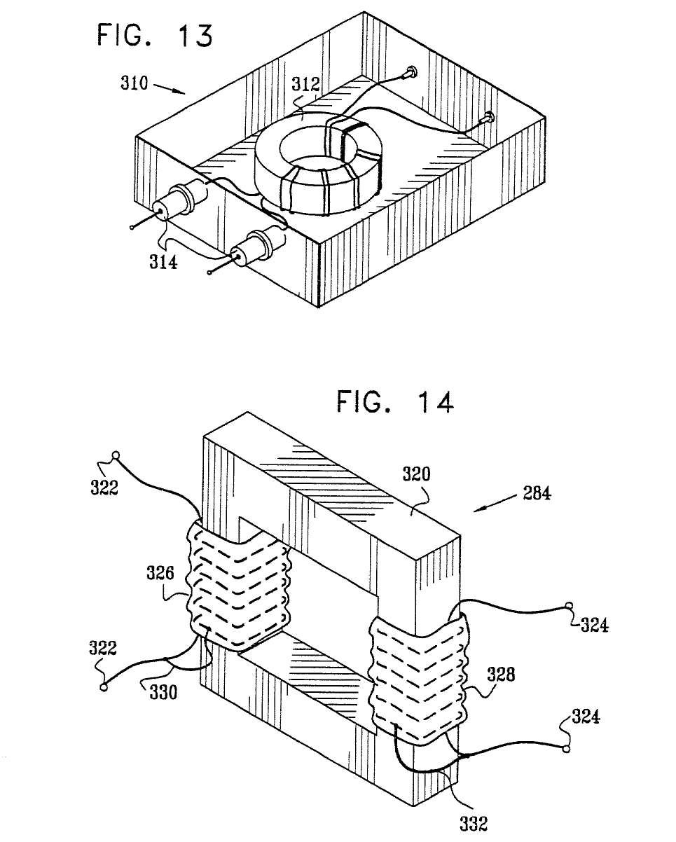

Reference is now made to FIG. 13, which is a simplified illustration of a packaged circuit 310 comprising a noise suppressor 312, preferably identical to the noise suppressor 10 of FIG. 1A, and two low pass EMI filters 314, each embodied in a feed-through device. Low pass EMI filters 314 are preferably similar in function to the low pass EMI filter assemblies 66 and 68 of FIG. 4.

Reference is now made to FIG. 14, which is a simplified illustration of a preferred implementation of the insulating transformer portion 284 of FIG. 11. The insulating transformer of FIG. 14 preferably comprises a core 320 that corresponds to core 290 of FIG. 11; a primary winding connecting terminals 322, corresponding to terminals 297 of FIG. 11; a secondary winding, connecting terminals 324 corresponding to terminals 298 of FIG. 11; and aluminum foil shields 326 and 328, corresponding to 288 and 294 of FIG. 11, respectively. Preferably, core 320 is made of ferrite material; of an amorphous magnetic material or of a combination of ferrite and amorphous magnetic materials. The shield 326 is connected to the terminal 322 via a connection 330 and similarly the shield 328 is connected to the terminal 324 via a connection 332.

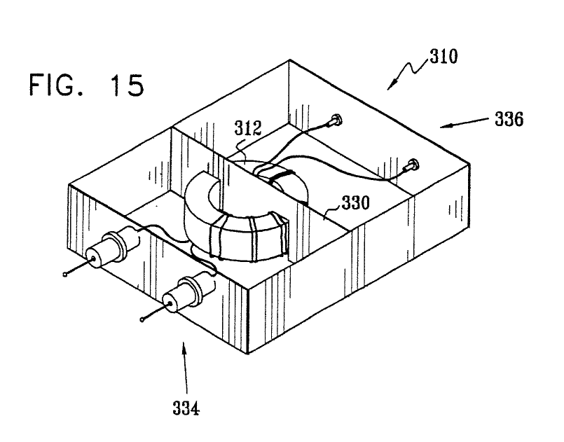

Reference is now made to FIG. 15, which is a simplified illustration of a packaged circuit providing reduced cross-over interference between the input terminals and the output terminals of a noise suppressor, such as noise suppressor 312 of FIG. 13. FIG. 15 shows the packaged circuit 310 of FIG. 13 with the addition of a metallic barrier 330 separating an input portion 334 of the circuit from an output portion 336 thereof. The metallic barrier 330 reduces the parasite capacitance between the input and the output of noise suppressor 312 and thus reduces the cross-over interference.

It will be appreciated by persons skilled in the art that the present invention is not limited by what has been particularly shown and described herein above. Rather the scope of the present invention includes both combinations and subcombinations of the various features described hereinabove as well as variations and modifications which would occur to persons skilled in the art upon reading the specifications and which are not in the prior art.

1. A communication circuit comprising:
communications circuitry having an input and an output; and
a noise suppressor comprising:
an amorphous magnetic core and
a bifilar winding around said amorphous magnetic core.

2. A noise suppressor assembly comprising:
a multiplicity of noise suppressors, at least one of said multiplicity of noise suppressors including:
an amorphous magnetic core; and
a bifilar winding wound around said amorphous magnetic core.

3. A noise suppressor assembly according to claim 2 and wherein said multiplicity of noise suppressors includes at least first and second noise suppressors having cores containing different amorphous magnetic materials.

4. A noise suppressor assembly comprising at least one noise suppressor including:
a core including ferrite and an amorphous magnetic material; and
a bifilar winding wound around said core.

5. A noise suppressor assembly according to claim 4 and wherein said at least one noise suppressor comprises a multiplicity of noise suppressors including at least first and second noise suppressors having cores containing different amorphous magnetic materials.

6. A wide band noise suppressor comprising
a core assembly comprising a multiplicity of amorphous magnetic cores; and
a bifilar winding wound around said core assembly.

7. A wide band noise suppressor comprising
a core comprising a mixture of a plurality of different amorphous magnetic materials; and
a bifilar winding wound around said core.

8. A signal to interference enhancer comprising:
at least one passive analog circuit operative to decrease radio frequency interference in a received signal; and
at least one active analog circuit operative to decrease radio frequency interference in said received signal,
said at least one passive analog circuit and said at least one active analog circuit being arranged in series for providing radio frequency signal to interference enhancement to said received signal.

9. A signal to interference enhancer according to claim 8 and wherein said at least one active analog circuit comprises a subtraction circuit which cancels common mode interference.

10. A signal to interference enhancer according to claim 8 and wherein said at least one passive analog circuit comprises a passive filter which reduces the amplitude of common mode interference.

11. A signal to interference enhancer according to claim 9 and wherein said at least one passive analog circuit operates in a frequency range which is at least partially non-overlapping with a frequency range of operation of said at least one active analog circuit.

12. A signal to interference enhancer according to claim 10 and wherein said at least one passive analog circuit operates in a frequency range which is at least partially non-overlapping with a frequency range of operation of said at least one active analog circuit.

13. A signal to interference enhancer according to claim 8 and wherein said at least one passive analog circuit is operative to reduce non-common mode interference due to imperfect balancing of first and second transmission lines by filtering the common mode interference.

14. A signal to interference enhancer according to claim 9 and wherein said at least one passive analog circuit is operative to reduce non-common mode interference due to imperfect balancing of first and second transmission lines by filtering the common mode interference.

15. A signal to interference enhancer according to claim 10 and wherein said at least one passive analog circuit is operative to reduce non-common mode interference due to imperfect balancing of first and second transmission lines by filtering the common mode interference.

16. A signal to interference enhancer according to claim 11 and wherein said at least one passive analog circuit is operative to reduce non-common mode interference due to imperfect balancing of first and second transmission lines by filtering the common mode interference.

17. A signal to interference enhancer according to claim 8 and wherein said at least one passive analog circuit comprises:
a low-pass EMI filter operative to attenuate interference at frequencies above a desired frequency pass band; and
a plurality of cascaded common mode chokes connected in series with said EMI filter, said common mode chokes being operative to attenuate interference at frequencies within said desired frequency pass band.

18. A signal to interference enhancer according to claim 17 and also comprising metallic barriers located at said filter and at said cascaded common mode chokes in order to reduce parasitic input to output interference coupling.

19. A signal to interference enhancer according to claim 17 and wherein said plurality of cascaded common mode chokes include at least one choke comprising:
at least one core comprising a metal-based amorphous material and a ferrite material; and
at least one coil wound about said at least one core.

20. A signal to interference enhancer according to claim 19 and wherein said ferrite material comprises silicon steel permalloy.

21. A signal to interference enhancer according to claim 19 and wherein said amorphous material has magnetic permeability between 20,000-100,000.

22. A signal to interference enhancer according to claim 21 and wherein said magnetic permeability varies with changes in temperature between −30° C. and 85° C. by less than 5%.

23. A signal to interference enhancer according to claim 19 and wherein said amorphous material has a saturation current of at least 5 Amperes.

24. A signal to interference enhancer according to claim 19 and wherein said at least one core comprises separate core elements made of said metal-based amorphous material and of said ferrite material.

25. A signal to interference enhancer comprising:
a low-pass EMI filter operative to attenuate interference at frequencies above a desired frequency pass band; and
a plurality of cascaded common mode chokes connected in series with said EMI filter, said common mode chokes being operative to attenuate interference at frequencies within said desired frequency pass band.

26. A signal to interference enhancer according to claim 25 and wherein said plurality of cascaded common mode chokes include
at least one choke comprising at least one core comprising a metal-based amorphous material and a ferrite material; and
at least one coil wound about said at least one core.

27. A signal to interference enhancer according to claim 26 and wherein said ferrite material comprises silicon steel permalloy.

28. A signal to interference enhancer according to claim 26 and wherein said amorphous material has magnetic permeability between 20,000-100,000.

29. A signal to interference enhancer according to claim 27 and wherein said magnetic permeability varies with changes in temperature between −30° C. and 85° C. by less than 5%.

30. A signal to interference enhancer according to claim 26 and wherein said amorphous material has a saturation current of at least 5 Amperes.

31. A signal to interference enhancer according to claim 26 and wherein said at least one core comprises separate core elements made of said metal-based amorphous material and of said ferrite material.

32. A signal to interference enhancer according to claim 25 and also comprising metallic barriers located at said filter and at said cascaded common mode chokes in order to reduce parasitic input to output interference coupling.

33. A signal to interference enhancer embodied in a circuit package and comprising:
a low-pass EMI filter operative to attenuate interference at frequencies above a desired frequency pass band;
a plurality of cascaded common mode chokes connected in series with said EMI filter, said common mode chokes being operative to attenuate interference at frequencies within said desired frequency pass band; and
metallic barriers located at said filter and at said cascaded common mode chokes in order to reduce parasitic input to output interference coupling.

34. A communication noise suppressing method comprising:
providing a communications circuitry having an input and an output;
providing an amorphous magnetic core;
winding a bifilar winding around said amorphous magnetic core and in series with at least one of said communications circuitry input and communications circuitry output; and
passing a communication signal from said input, through said bifilar winding and to said output for suppressing noise in said communication signal.

35. A noise suppressing method comprising:
providing a multiplicity of magnetic cores, at least one of said multiplicity of magnetic cores comprising an amorphous magnetic core;
winding a bifilar winding around each of said plurality of magnetic cores;
connecting said bifilar windings in series; and
passing a signal through said bifilar windings for suppressing noise in said signal.

36. A noise suppressing method comprising:
providing at least one core including ferrite and an amorphous magnetic material;
winding a bifilar winding around said at least one core; and
passing a signal through said bifilar winding for suppressing noise in said signal.

37. A noise suppressing method according to claim 35 and wherein said at least one core comprises a multiplicity of cores including at least first and second cores containing different amorphous magnetic materials.

38. A wide band noise suppressing method comprising:
providing a core assembly comprising a multiplicity of amorphous magnetic cores;
winding a bifilar winding wound around said core assembly; and
passing a signal through said bifilar winding for suppressing noise in said signal.

39. A wide band noise suppressing method comprising:
providing a core comprising a mixture of a plurality of different amorphous magnetic materials;
winding a bifilar winding wound around said core; and
passing a signal through said bifilar winding for suppressing noise in said signal.

40. A signal to interference enhancing method comprising:
providing at least one passive analog circuit operative to decrease radio frequency interference in a received signal;
providing at least one active analog circuit operative to decrease radio frequency interference in said received signal;
arranging said at least one passive analog circuit and said at least one active analog circuit in series; and
passing a radio frequency signal through said passive analog circuit and said active analog circuit for enhancing said signal to interference therein.

41. A signal to interference enhancing method according to claim 40 and wherein said at least one active analog circuit cancels common mode interference.

42. A signal to interference enhancing method according to claim 40 and wherein said at least one passive analog circuit reduces the amplitude of common mode interference.

43. A signal to interference enhancing method according to claim 40 and wherein said at least one passive analog circuit operates in a frequency range which is at least partially non-overlapping with a frequency range of operation of said at least one active analog circuit.

44. A signal to interference enhancing method according to claim 42 and wherein said at least one passive analog circuit operates in a frequency range which is at least partially non-overlapping with a frequency range of operation of said at least one active analog circuit.

45. A signal to interference enhancing method according to claim 40 and wherein said at least one passive analog circuit is operative to reduce non-common mode interference due to imperfect balancing of first and second transmission lines by filtering the common mode interference.

46. A signal to interference enhancing method according to claim 41 and wherein said at least one passive analog circuit is operative to reduce non-common mode interference due to imperfect balancing of first and second transmission lines by filtering the common mode interference.

47. A signal to interference enhancing method according to claim 42 and wherein said at least one passive, analog circuit is operative to reduce non-common mode interference due to imperfect balancing of first and second transmission lines by filtering the common mode interference.

48. A signal to interference enhancing method according to claim 43 and wherein said at least one passive analog circuit is operative to reduce non-common mode interference due to imperfect balancing of first and second transmission lines by filtering the common mode interference.

49. A signal to interference enhancing method according to claim 40 and wherein:
said at least one passive analog circuit employs an EMI filter to attenuate interference at frequencies above a desired frequency pass band and employs a plurality of cascaded common mode chokes connected in series with said EMI filter to attenuate interference at frequencies within said desired frequency pass band.

50. A signal to interference enhancing method according to claim 49 and also comprising employing metallic barriers located at said filter and at said cascaded common mode chokes to reduce parasitic input to output interference coupling.

51. A signal to interference enhancing method according to claim 50 and wherein said at least one core comprises separate core elements made of said metal-based amorphous material and of said ferrite material.

52. A signal to interference enhancing method comprising:
employing a low-pass EMI filter to attenuate interference above a desired frequency pass band;
employing a plurality of cascaded common mode chokes connected in series with said EMI filter to attenuate interference at frequencies within said desired frequency pass band; and
passing a signal through said low-pass EMI filter and said plurality of cascaded common mode chokes for suppressing noise in said signal.

53. A signal to interference enhancing method according to claim 52 and also comprising metallic barriers located at said filter and at said cascaded common mode chokes in order to reduce parasitic input to output interference coupling.

54. A signal to interference enhancing method comprising:
employing a low-pass EMI filter to attenuate interference at frequencies above a desired frequency pass band;
employing a plurality of cascaded common mode chokes connected in series with said EMI filter to attenuate interference at frequencies within said desired frequency pass band; and
employing a metallic barriers located at said filter and at said cascaded common mode chokes to reduce parasitic input to output interference coupling.

55. A signal to interference enhancer according to claim 56 and wherein said amorphous material comprises at least one of cobalt and nickel.

56. A. A signal to interference enhancer according to claim 26 and wherein said amorphous material comprises at least one of cobalt and nickel.

57. A noise suppressor comprising:
an amorphous magnetic core; and
a bifilar winding wound around said amorphous magnetic core, and
wherein said amorphous magnetic core has a closed E shape.

58. A noise suppressor according to claim 1 and wherein said amorphous magnetic core has a toroidal shape.

59. A noise suppressor according to claim 1 and wherein said amorphous magnetic core has a closed E shape.

60. A noise suppressor according to claim 6 and wherein said amorphous magnetic core has a toroidal shape.

61. A noise suppressor according to claim 6 and wherein said amorphous magnetic core has a closed E shape.

62. A noise suppressor according to claim 7 and wherein said amorphous magnetic core has a toroidal shape.

63. A noise suppressor according to claim 7 and wherein said amorphous magnetic core has a closed E shape.

64. A signal to interference enhancer comprising:
at least one passive analog circuit operative to decrease radio frequency interference in a received signal; and
at least one active analog circuit operative to decrease radio frequency interference in said received signal,
said at least one passive analog circuit and said at least one active analog circuit being arranged in series for providing radio frequency signal to interference enhancement to said received signal; and
said at least one active analog circuit operative to interface with a modem.

65. A signal to interference enhancer comprising:
at least one passive analog circuit operative to decrease radio frequency interference in a received signal; and
at least one active analog circuit operative to decrease radio frequency interference in said received signal,
said at least one passive analog circuit and said at least one active analog circuit being arranged in series for providing radio frequency signal to interference enhancement to said received signal; and
said at least one active analog circuit operative to interface with an A/D converter.

66. A signal to interference enhancing repeater comprising:
a first passive analog circuit operative to decrease radio frequency interference in a received signal;
at least one active analog circuit operative to decrease radio frequency interference in said received signal; and
a second passive analog circuit operative to decrease radio frequency interference in a received signal,
said first passive analog circuit and said active analog circuit and said second passive analog circuit being arranged in series for providing radio frequency signal to interference enhancement to said received signal; and
said at least one active analog circuit operative as an analog repeater.

67. A signal to interference enhancer comprising:
at least one passive analog circuit comprising a differential input and operative to decrease radio frequency interference in a received signal; and
at least one active analog circuit comprising a single-ended output and operative to decrease radio frequency interference in said received signal,
said at least one passive analog circuit and said at least one active analog circuit being arranged in series for providing radio frequency signal to interference enhancement to said received signal; and wherein said differential input serves as the input of the cascaded circuit and said single-ended output serves as the output of the cascaded circuits.

68. A signal to interference enhancer comprising:
at least one passive analog circuit operative to decrease radio frequency interference in a received signal; and
at least one active analog circuit operative to decrease radio frequency interference in said received signal,
said at least one passive analog circuit and said at least one active analog circuit being arranged in series for providing radio frequency signal to interference enhancement to said received signal; and
the first said of at least one passive analog circuit comprising a differential input and the last of said at least one active analog circuit comprising a single-ended output.

69. A signal to interference enhancer comprising:
at least one passive analog circuit operative to decrease radio frequency interference in a received signal; and
at least one active analog circuit operative to decrease radio frequency interference in said received signal,
said at least one passive analog circuit and said at least one active analog circuit being arranged in series for providing radio frequency signal to interference enhancement to said received signal; and
the first of said at least one passive analog circuit comprising a single-ended input and the last of said at least one active analog circuit comprising a single-ended output.

70. A signal to interference enhancer comprising:
at least one passive analog circuit operative to decrease radio frequency interference in a received signal; and
at least one active analog circuit operative to decrease radio frequency interference in said received signal,
said at least one passive analog circuit and said at least one active analog circuit being arranged in series for providing radio frequency signal to interference enhancement to said received signal; and
the first of said at least one passive analog circuit comprising a single-ended input and the last of said at least one active analog circuit comprising a differential output.

71. A signal to interference enhancer comprising:
at least one passive analog circuit operative to decrease radio frequency interference in a received signal; and
at least one active analog circuit operative to decrease radio frequency interference in said received signal,
said at least one passive analog circuit and said at least one active analog circuit being arranged in series for providing radio frequency signal to interference enhancement to said received signal; and
said at least one active analog circuit operative to interface with an XDSL modem.

72. A noise suppressing transformer assembly comprising:
at least one noise suppressor comprising:
an amorphous magnetic core; and
a bifilar winding wound around said amorphous magnetic core; and
a transformer comprising:
at least one core comprising at least a ferrite material; and
at least one coil wound about said at least one core,
said at least one noise suppressor and said transformer being arranged in series.

73. A signal to interference enhancer embodied in a circuit package and comprising:
a low-pass EMI filter operative to attenuate interference at frequencies above a desired frequency pass band; and
a plurality of cascaded common mode chokes connected in series with said EMI filter, said common mode chokes being operative to attenuate interference at frequencies within said desired frequency pass band; and
each of said low-pass EMI filter and said plurality of cascaded common mode being contained in a separate metallic enclosure.

74. A signal to interference enhancer embodied in a circuit package and comprising:
a low-pass EMI filter operative to attenuate interference at frequencies above a desired frequency pass band; and
a plurality of cascaded common mode chokes connected in series with said EMI filter, said common mode chokes being operative to attenuate interference at frequencies within said desired frequency pass band;
said plurality of cascaded common mode chokes being contained in a metal enclosure and said EMI filter being embodied in a feed-through device inserted in a wall of said enclosure.

75. A transformer comprising:
at least one core comprising at least one of metal-based amorphous material and a ferrite material;
at least one coil wound about said at least one core; and
at least one aluminum foil shield wound around at said least one coil.

76. A noise suppressor embodied in a circuit package comprising:
an amorphous magnetic core;
a bifilar winding wound around said amorphous magnetic core, said bifilar winding comprising an input portion and an output portion; and
a metallic barrier located across said amorphous magnetic core and between said input portion and said output portion in order to reduce parasitic input to output interference coupling.
